(19) United States
(12) Patent Application Publication
(10) Pub. No.: US 2020/0174475 A1
(43) Pub. Date: Jun. 4, 2020

(54) AUTONOMOUS DRIVING METHOD AND SYSTEM

(71) Applicant: Electronics and Telecommunications Research Institute, Daejeon (KR)

(72) Inventors: Kyoung Wook MIN, Sejong-si (KR); Jeong Dan CHOI, Daejeon (KR); Yong Woo JO, Daejeon (KR); Seung Jun HAN, Daejeon (KR)

(73) Assignee: Electronics and Telecommunications Research Institute, Daejeon (KR)

(21) Appl. No.: 16/698,763

(22) Filed: Nov. 27, 2019

(30) Foreign Application Priority Data
Nov. 29, 2018 (KR) 10-2018-0150888

(51) Int. Cl. G05D 1/00; G05D 1/02

(52) U.S. Cl. CPC G05D 1/0088; G05D 1/0278

(57) ABSTRACT

Provided is an autonomous driving method. The autonomous driving method includes a global driving planning operation in which global guidance information for global node points are acquired, a host vehicle location determination operation, an information acquisition operation in which information regarding an obstacle and a road surface marking within a preset distance ahead is acquired, a local precise map generation operation in which a local precise map for a corresponding range is generated using the information acquired within the preset distance ahead, a local route planning operation in which a local route plan for autonomous driving within at least the preset distance is established using the local precise map, and an operation of controlling a host vehicle according to the local route plan to perform autonomous driving.

### CROSS-REFERENCE TO RELATED APPLICATION

This application claims priority to and the benefit of Korean Patent Application No. 10-2018-0150888, filed on Nov. 29, 2018, the disclosure of which is incorporated herein by reference in its entirety.

### BACKGROUND

### 1. Field of the Invention

The present invention relates to autonomous driving technology.

### 2. Discussion of Related Art

The statements in this section merely provide background information related to embodiments of the present invention and may not constitute a related art.

Recently, research on autonomous driving has been actively conducted. For autonomous driving, it is necessary to accurately recognize an external environment through sensors or the like and determine driving conditions such as driving direction and speed on the basis of the recognized information.

Radars and the like are used as the sensors for recognizing an external environment, but the use of vision sensors is becoming active to recognize more information. Vision sensors have been spotlighted in terms of relatively low prices compared to other sensors.

In this regard, a technique for recognizing the external environment of a vehicle by pattern recognition or image processing has been greatly developed, which is expected to be very helpful for autonomous driving.

In order to perform autonomous driving, a map is needed. In this case, it is recognized that a high-precision map is required rather than a road network information level map such as a conventional navigation map.

The high-precision map includes, for example, the following information.
Road surface marking data: road lines (dotted lines, solid lines, double lines, road boundaries, etc.), road surface markings (letters, numbers, arrows, etc.), stop lines, crosswalks, etc.
Lane centerline data: centerline data with respect to a road lane between road lines (including crossroads)
Traffic light data: signal data including height information

By using high-precision map data, autonomous driving technology implements the following features.
Autonomous vehicle location recognition: recognition of the location/heading of a vehicle through matching between data recognized from a sensor (road surface marking data) and pre-built high-precise map data
Dynamic obstacle mapping: mapping about whether an obstacle (location, size, speed, type) recognized in real time is in a driving lane, in a left or right lane, or in a lane with a danger of collision at a (non-) signal intersection
Static map element mapping: mapping about whether a stop line, a crosswalk, or a speed bump is placed in the driving lane.
Local route generation: generation of a local route that an autonomous vehicle can follow (control) to travel in a lane, change lanes, and pass through an intersection

These high-precise maps are generated by collecting data by means of a vehicle equipped with an expensive sensor (a mobile mapping system (MMS)) and performing post-processing on the data, and it is costly and time-consuming to keep the maps up-to-date.

### SUMMARY OF THE INVENTION

The present invention is directed to providing a technique capable of autonomous driving without high-precision maps.

In particular, the present invention is directed to providing a technique capable of establishing a plan to drive to a destination even in the absence of high-precision map data.

According to an aspect of the present invention, there is provided an autonomous driving method including a global driving planning operation in which global guidance information for global node points are acquired, a host vehicle location determination operation, an information acquisition operation in which information regarding an obstacle and a road surface marking within a preset distance ahead is acquired, a local precise map generation operation in which a local precise map for a corresponding range is generated using the information acquired within the preset distance ahead, a local route planning operation in which a local route plan for autonomous driving within at least the preset distance is established using the local precise map, and an operation of controlling a host vehicle according to the local route plan to perform autonomous driving.

In at least one embodiment of the present invention, the local precise map generation operation may include generating a local precise road map within the preset distance from the road surface marking, classifying the obstacle information into a dynamic obstacle and a static obstacle, and generating a local precise map by matching the local precise road map and the static obstacle.

Also, in at least one embodiment of the present invention, the local precise map generation operation may further include matching the local precise road map and the static obstacle to a road network map.

In at least one embodiment of the present invention, the road surface marking may include a driving attribute marking including a road line.

Also, in at least one embodiment of the present invention, the driving attribute marking may include at least one of a road line attribute marking, a driving direction marking, a speed limit marking, a stop line marking, a crosswalk marking, a school/silver zone marking, and a speed bump marking.

Also, in at least one embodiment of the present invention, the road surface marking may further include a constraint property marking including a general road or a bus-only lane.

In at least one embodiment of the present invention, the road surface marking may further include an intersection attribute marking including a general intersection or a roundabout.

In at least one embodiment of the present invention, the host vehicle location determination may be performed by an in-vehicle sensor (e.g., an inertial sensor) and odometry information or by Global Positioning System (GPS) information.

Also, in at least one embodiment of the present invention, the autonomous driving method may further include an intersection driving operation in which a local route plan varies depending on whether an exit is successfully recognized.

In at least one embodiment of the present invention, the intersection driving operation may include generating an intersection passage lane center line using an entrance and the exit and establishing the local route plan when the recognition of the exit is successful.

Also, in at least one embodiment of the present invention, the intersection driving operation may include establishing a local route plan following a vehicle ahead or receiving intersection passage lane center line data from a cloud server to establish a local route plan when the recognition of the exit fails.

In at least one embodiment of the present invention, the local route planning operation may include performing the local route plan according to an action order generated by global guidance information for at least a first subsequent global node point immediately ahead.

Also, in at least one embodiment of the present invention, when it is difficult to execute the local route plan according to the action order, the global guidance information for at least the first subsequent global node point may be changed. In at least one embodiment of the present invention, the action order may be generated in additional consideration of global guidance information for a second subsequent global node point.

Also, in at least one embodiment of the present invention, the first subsequent global node point and the second subsequent global node point may be placed within a preset distance from each other.

### BRIEF DESCRIPTION OF THE DRAWINGS

FIG. 1 is a flowchart of autonomous driving technology according to an embodiment of the present invention.

FIG. 2A to FIG. 2C shows a processing status of each module and a configuration of the autonomous driving system according to an embodiment of the present invention.

FIG. 3 illustrates an autonomous driving situation.

FIG. 4A to FIG. 4B is a flowchart illustrating an autonomous driving situation at an intersection.

FIG. 5 is a reference diagram illustrating a case in which it is difficult to change lanes while the lane change is necessary according to a local route plan.

FIG. 6A to FIG. 6B is a flowchart illustrating a method for a situation that requires coping with the case in which it is difficult to change lanes while the lane change is necessary according to a local route plan.

FIG. 7A to FIG. 7B is a flowchart illustrating a method for a case in which driving to one node point is executed and then there is not enough time to plan and execute a local route for a subsequent global node point.

### DETAILED DESCRIPTION OF EXEMPLARY EMBODIMENTS

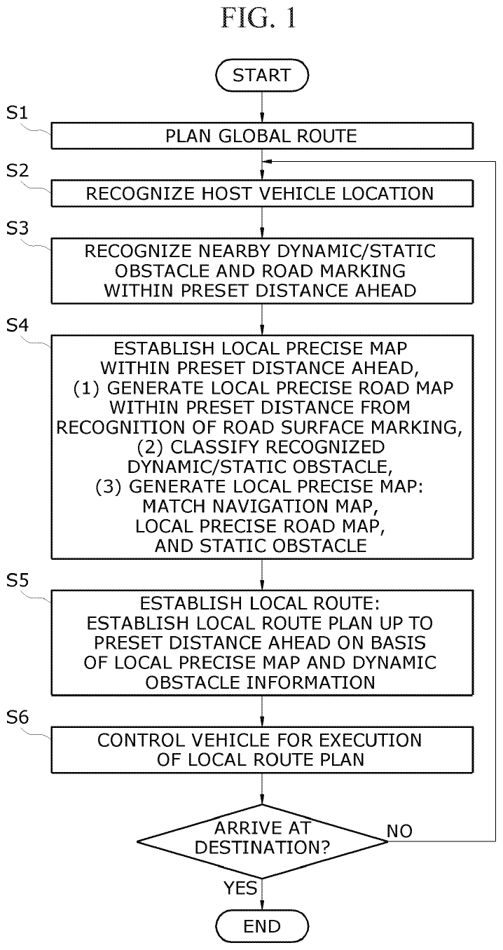

First, an autonomous driving method according to one embodiment of the present invention will be described with reference to FIG. 1.

When autonomous driving is started, a global route is planned as a route to a destination (S1). The global driving route planning may be performed in the same or a similar manner as or to route planning performed in a conventional navigation device.

As a detailed example, the global driving route planning may be as follows.
(First global route planning): Turn left at intersection [ooo] and then go straight in second lane for 3 km
(Second global route planning): Turn right at intersection [xxx] and then go straight for 10 km

. . .
Arrive at destination

A map used to generate the global route plan does not necessarily need to be a high-precision map, and any map usable by a current navigation system to provide guidance information for a destination to a driver may be utilized. For example, a map including only road network information or the like may be utilized. That is, a map other than a high-precision map built using expensive equipment may be utilized in an embodiment of the present invention.

After the global route plan is generated, the vehicle system recognizes the location of a host vehicle (S2).

The relative location coordinates of the host vehicle may be calculated and acquired by a convergence of image-based odometry and in-vehicle sensors. Also, either a high-precision global positioning system (GPS) device or a low-cost global positioning system (GPS) device having precision used in a conventional navigation system may be used for the absolute location of the host vehicle. Such a location acquisition technique for the host vehicle is already well known.

When the location of the host vehicle is recognized, the autonomous vehicle travels a section between global node points. In this case, the autonomous vehicle recognizes an obstacle such as a nearby vehicle and recognizes road line information (S3), and performs autonomous driving using the recognized information. As an example, the road line information may be recognized using an image sensor, and the obstacle may be recognized by a LiDAR, a radar, an image sensor, or a combination thereof. As an exemplary autonomous driving method, the autonomous vehicle recognizes road lines of a current driving lane and travels while maintaining a predetermined distance inward from the road lines. As an example, the autonomous vehicle travels from an n−1^{st} global node point to an n^{th} global node point according to an n−1^{st} global route plan. After reaching the n^{th} global node point, the autonomous vehicle travels to an n+1^{st} global node point according to an n^{th} global route plan. By repeating such a process, the autonomous vehicle arrives at a destination, and the autonomous driving is complete.

While performing the autonomous driving, the autonomous vehicle recognizes road lines, lanes, and various road surface markings (arrow signs indicating to turn left, turn right, and go straight, speed signs, stop lines, and the like) and nearby obstacles (nearby vehicles, nearby stationary obstacles, pedestrians, and the like) by means of sensors and builds a local precise map for a preset distance ahead.

For example, the local precise map is built within the preset distance as followings:

\textcircled{1} Generate a local precise road map within a preset distance from the recognition of road surface markings, \textcircled{2} dynamically or statically classify recognized obstacles, and \textcircled{3} generate a local precise map. When a navigation map, a local precise road map, and a static-obstacle-matching local precise map are built (S4), a local route plan for driving within the preset distance ahead is generated using the maps (S5). That is, a route for autonomous driving up to the front preset distance is planned based on the local precise map and the dynamic obstacle information. Here, preferably, the preset distance is within a distance range recognizable through a sensor.

When the local route plan is generated in this way, the autonomous vehicle autonomously travels the preset distance according to the local route plan (S6).

By repeating the local route planning and the autonomous driving, the autonomous vehicle travels to the destination according to the global route plan, and the autonomous driving is complete.

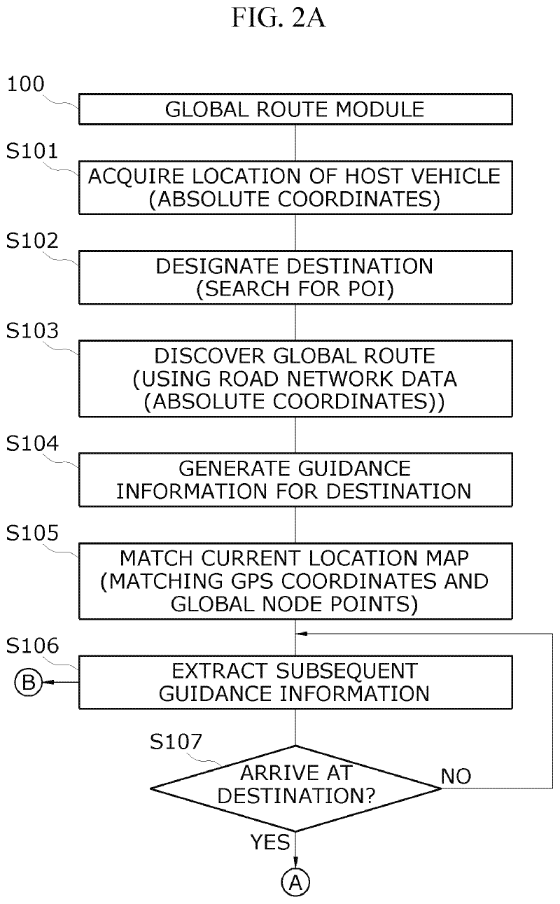

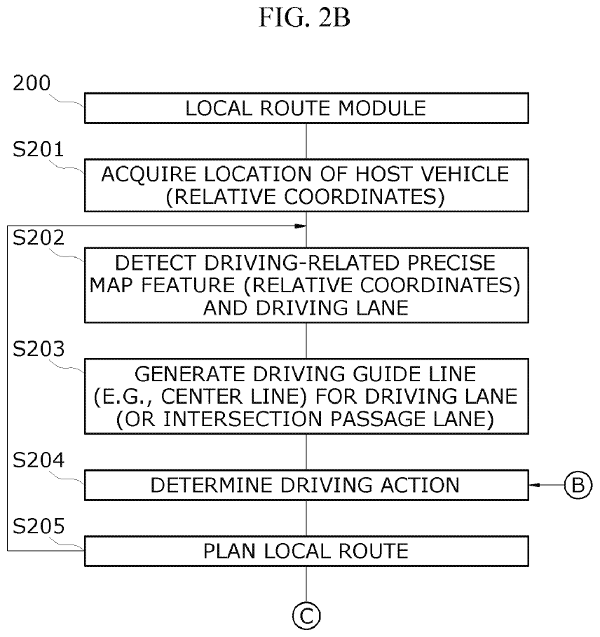

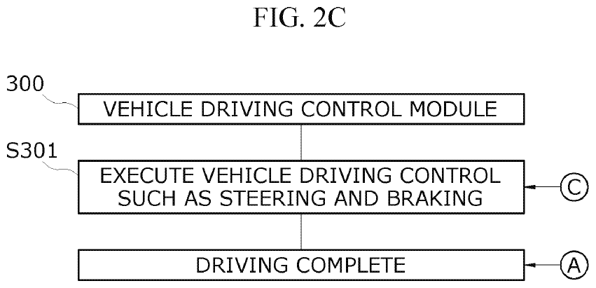

FIG. 2A to FIG. 2C shows another example of the autonomous driving method according to an embodiment of the present invention. An autonomous driving system may include a program and a device installed in a vehicle and may include a global route module 100, a local route module 200, and a vehicle driving control module 300.

Here, the modules may be physically distinct from each other or may be integrated as a single device or program. In an embodiment of the present invention, the modules are used only to distinguish from each other according to their functions for convenience of description and thus should be construed as giving no limitation to the present invention.

First, the global route module 100 acquires the location (absolute coordinates) of a host vehicle (S101). Here, the location of the host vehicle is absolute coordinates and is preferably obtained through a GPS device. The GPS device does not need to be a high-precision GPS device, and a low-cost GPS suitable to be used in a conventional navigation system may be utilized. The acquisition of the location of the host vehicle is periodically performed, and the acquired locations are used for map matching for a traveling route during the autonomous traveling.

Also, the global route module 100 designates a destination (S102) and searches for a global route (S103). The global route search may be performed using road network data as in the above embodiment. That is, a low-cost map rather than a high-precision map may be used.

The global route module 100 discovers the global route and generates guidance information for the destination (S104). That is, the global route module 100 generates guidance information including a route to reach the destination and travel direction change information at global node points, which are travel direction changing points on the route.

The map matching for the route is performed using the acquired location of the host vehicle (S105) and is continuously performed until the host vehicle arrives at the destination during the autonomous driving.

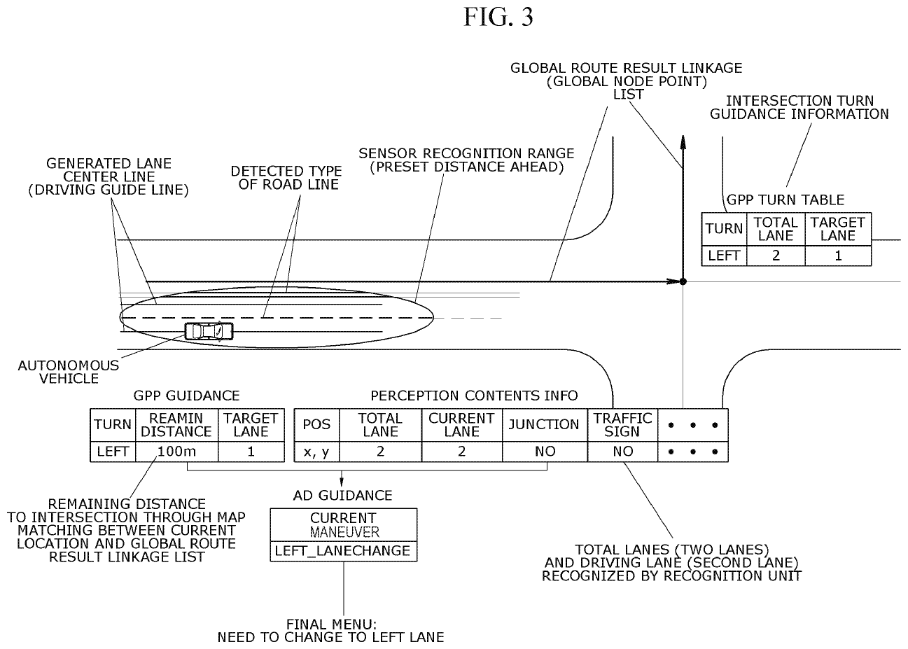

The global route module 100 may extract subsequent guidance information through the map matching (S106) and may send the subsequent guidance information to the local route module 200 to be described below so that the subsequent guidance information is used for the local route planning. For example, as shown in FIG. 3, when the current location of the host vehicle is 100 m before reaching an intersection [ooo] (one of the global node points) ahead, where the host vehicle is supposed to turn left according to the global route plan, the global route module 100 extracts “turn left at intersection [ooo]” as the subsequent guidance information and sends the information to the local route module 200.

The local route module 200 acquires the location (relative coordinates) of the host vehicle along with the onset of autonomous driving (S201). The relative coordinate location of the host vehicle may be calculated and acquired by a convergence of image-based odometry and in-vehicle sensors.

The local route module 200 detects a driving lane, traveling-related precise-map features (dynamic and stationary obstacles), and the like within a preset distance range ahead (S202). As an example, as in the above embodiment, the lane information may be recognized using an image sensor, and the obstacle may be recognized by a LiDAR, a radar, an image sensor, or a combination thereof.

Also, the lane information includes road lines, lanes, and various road surface markings (arrow signs indicating to turn left, turn right, and go straight, speed signs, stop lines, and the like), and the obstacle includes nearby vehicles, nearby stationary obstacles, pedestrians, and the like.

As shown in FIG. 3, a current driving lane may be ascertained from the lane information, and a left lane and a right lane may be ascertained with respect to the driving lane. Traveling in the current driving lane is performed by generating a driving guide line (S203) and following the generated driving guide line.

For example, the driving guide line may be one of a left road line, a right road line, and a virtual central line of the lane.

Meanwhile, the local route module 200 receives the subsequent guidance information from the global route module 100 as described above and determines a driving action according to the information (S204). As an example, as in the above example, the local route module 200 receives “Left turn at intersection [ooo]” as the subsequent guidance information. In this case, when the current driving lane is a straight lane, the local route module 200 may determine “change a driving lane to the left lane” as the driving action as shown in FIG. 3 in order to turn left at the intersection.

Also, the local route module 200 plans a local route in order to execute the driving action (S205) and sends the local route plan to the vehicle driving control module 300. The vehicle driving control module 300 controls the vehicle's driving-associated devices such as a steering device, a braking device, and the like in order to execute the local route plan (S301).

A process of recognizing lane information and nearby obstacle information, generating a local precise map, establishing a local route plan, and controlling a vehicle's driving-associated devices accordingly is continuously repeated during the autonomous driving and is ended when it is determined that the autonomous vehicle arrives at the destination.

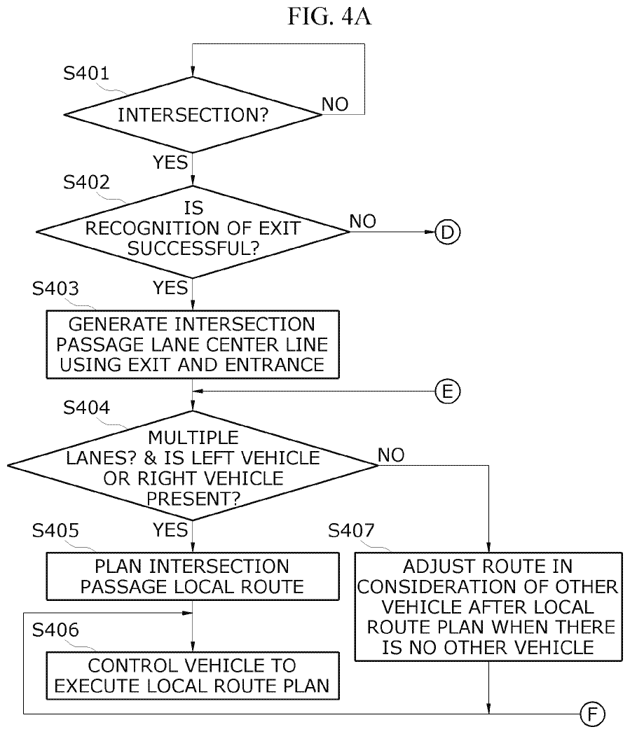

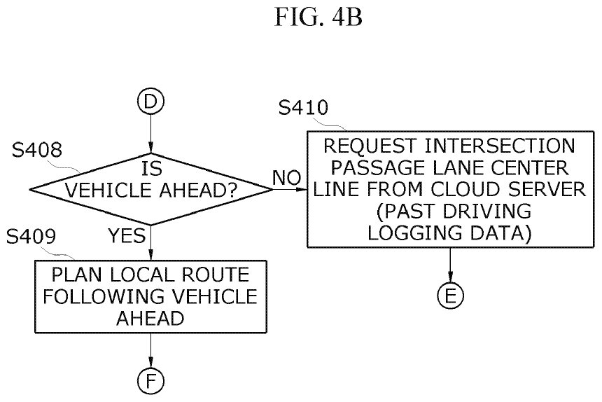

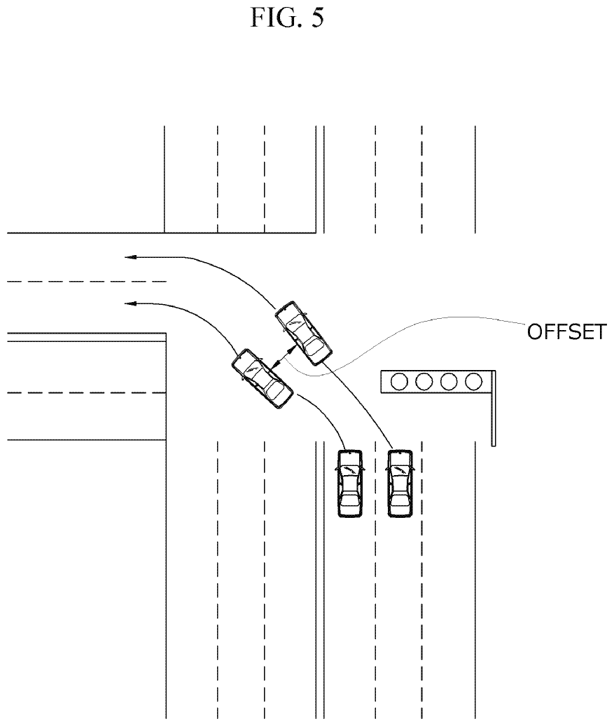

In the case of intersection passing, the method shown in FIG. 4A to FIG. 4B may be used.

\textcircled{1} First, when an intersection is determined (S401), an exit is recognized (S402).

\textcircled{2} When the exit is recognized, a driving guide line for a passage lane from an entrance to the exit (e.g., a passage lane center line) is generated when the exit is recognized (S403).

\textcircled{3} In this case, whether an intersection passage lane has multiple lanes and whether there are other vehicles to the left or right are determined (S404).

\textcircled{4} When the intersection passage lane does not have multiple lanes and there are no vehicles to the left or right, a local route plan is established along the intersection passage lane center line (S304), and thus the intersection passage driving is executed (S406).

\textcircled{5} In this case, when the intersection passage lane has multiple lanes and there is a vehicle to the left or right, a local route plan is established along the intersection passage lane center line on the assumption that the vehicle is not present and then the local route plan established in consideration of the vehicle is adjusted (S407). \textcircled{6} On the other hand, when the recognition of the exit fails in operation \textcircled{1} (for example, when a distance to the exit is outside a sensor recognition range or when the recognition fails due to the presence of an obstacle), it is determined whether there is a vehicle ahead (S408).

\textcircled{7} When it is determined in operation \textcircled{6} that there is a vehicle ahead (Y), a local route plan is established such that the vehicle ahead is followed (S409), and the autonomous driving is executed according to the local route plan.

\textcircled{8} On the other hand, when it is determined in operation \textcircled{6} that there is no vehicle ahead (N), data regarding a driving guide line of an intersection passage lane is requested (S410) and received from a cloud server or the like to perform intersection passing using the data. Here, the driving guide line data may be, for example, logging data generated while other vehicles were passing through the corresponding intersection.

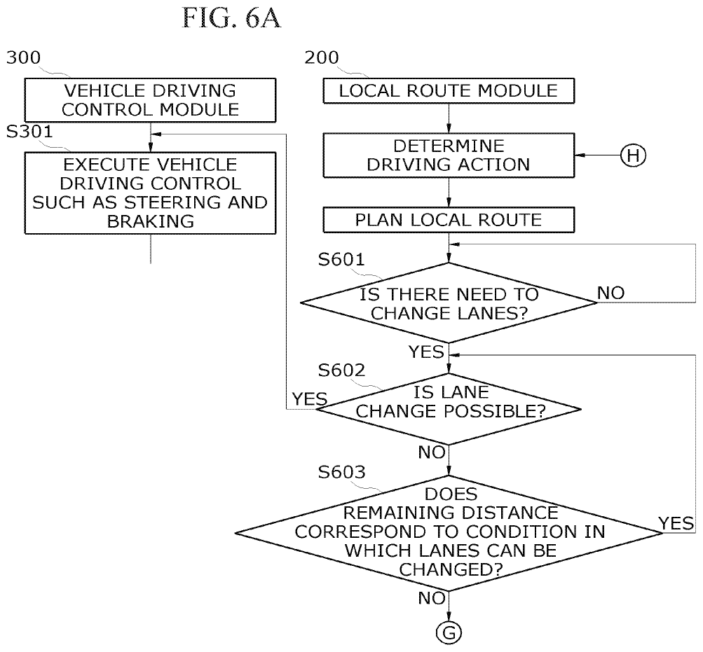

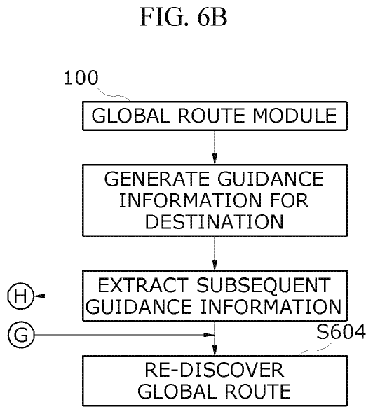

Meanwhile, there is a need to cope with a case in which it is difficult to change lanes while the lane change is necessary according to a local route plan. In this regard, an embodiment of FIG. 6A to FIG. 6B will be described.

It is determined whether there is a need to change lanes (S601) and whether the lane change is possible (S602). When the lane change is possible, the lane change is performed.

The lane change is not possible when a change timing is missing because a traveling vehicle is present on a target lane or when a target lane is congested because many vehicles are in the target lane.

In this case, the autonomous vehicle may search for a changeable situation while keeping traveling in the current driving lane.

However, since the host vehicle still goes straight during the search, the remaining distance may be shortened, and thus it may be determined that it is no longer possible to change lanes (S603). In this case, the subsequent global node point and the guidance information may be changed by re-discovering a global route (S604).

For example, it is assumed that “Turn left at intersection ahead” is extracted as the subsequent guidance information while a vehicle is traveling in a straight lane, a driving action is determined and a local route is planned according to the subsequent guidance information, and thus the vehicle has to move to the left lane. In this case, when the lane change is not performed until the vehicle reaches a preset distance from the intersection ahead, a global route is re-discovered according to a request, and the vehicle may travel according to the changed global route indicating to turn left at the next intersection.

Meanwhile, the distances between consecutive global node points are so short that a local route may be planned and executed for each node point. In this case, there may not be enough time to plan and execute a local route for a node point after traveling for the preceding node points.

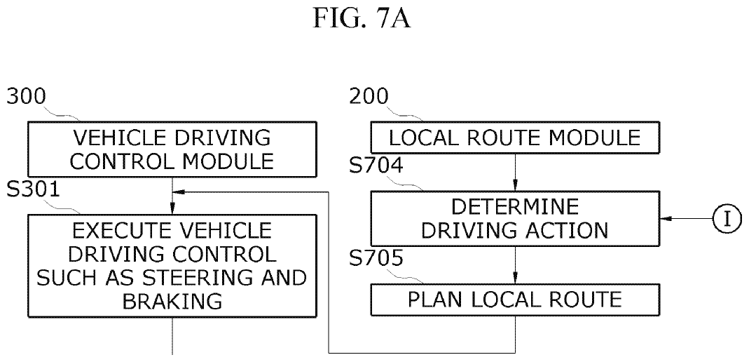

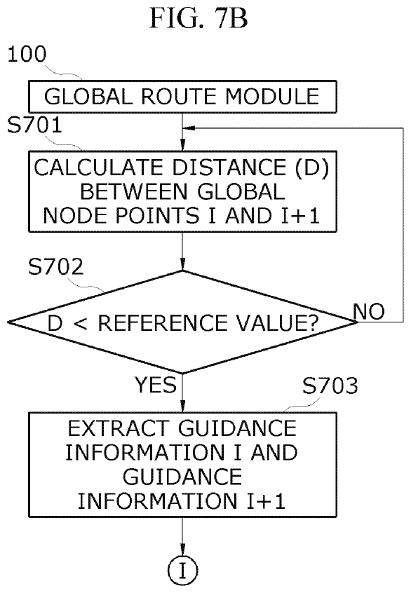

In this case, as shown in FIG. 7A to FIG. 7B, it is preferable that an integrated local route be planned in additional consideration of guidance information regarding two consecutive node points.

That is, a distance d between global node points i and i+1 is calculated (S701). Whether the distance d between the global node points i and i+1 is less than or equal to a reference value D is determined (S702). When the distance d is less than or equal to the reference value D (Y), guidance information i for the node point i and guidance information i+1 for the node point i+1 are also extracted (S703). According to the guidance information i and the guidance information i+1, a driving action is determined (S704), and a local route is planned (S705).

With the autonomous driving technology according to the present invention, it is possible to allow autonomous driving without a high-precision map.

Although the embodiments of the present invention have been described, these are merely examples and are not intended to limit the present invention. Therefore, no expression should be construed as a restrictive element.

What is claimed is:

1. An autonomous driving method comprising:
a global driving planning operation in which global guidance information for global node points are acquired;
a host vehicle location determination operation;
an information acquisition operation in which information regarding an obstacle and a road surface marking within a preset distance ahead is acquired;
a local precise map generation operation in which a local precise map for a corresponding range is generated using the information acquired within the preset distance ahead;
a local route planning operation in which a local route plan for autonomous driving within at least the preset distance is established using the local precise map; and
an operation of controlling a host vehicle according to the local route plan to perform autonomous driving.

2. The autonomous driving method of claim 1, wherein the local precise map generation operation comprises:
generating a local precise road map within the preset distance from the road surface marking;
classifying the obstacle information into a dynamic obstacle and a static obstacle; and
generating a local precise map by matching the local precise road map and the static obstacle.

3. The autonomous driving method of claim 2, wherein the local precise map generation operation further comprises matching the local precise road map and the static obstacle to a road network map.

4. The autonomous driving method of claim 1, wherein the road surface marking comprises a driving attribute marking including a road line.

5. The autonomous driving method of claim 4, wherein the driving attribute marking comprises at least one of a road line attribute marking, a driving direction marking, a speed limit marking, a stop line marking, a crosswalk marking, a school/silver zone marking, and a speed bump marking.

6. The autonomous driving method of claim 4, wherein the road surface marking further comprises a constraint property marking including a general road or a bus-only lane.

7. The autonomous driving method of claim 4, wherein the road surface marking further comprises an intersection attribute marking including a general intersection or a roundabout.

8. The autonomous driving method of claim 1, wherein the host vehicle location determination is performed by an in-vehicle sensor (e.g., an inertial sensor) and odometry information or by high-precision Global Positioning System (GPS) information.

9. The autonomous driving method of claim 1, further comprising an intersection driving operation in which a local route plan varies depending on whether an exit is successfully recognized.

10. The autonomous driving method of claim 9, wherein the intersection driving operation comprises generating an intersection passage lane center line using an entrance and the exit and establishing the local route plan when the recognition of the exit is successful.

11. The autonomous driving method of claim 9, wherein the intersection driving operation comprises establishing a local route plan following a vehicle ahead or receiving intersection passage lane center line data from a cloud server to establish a local route plan when the recognition of the exit fails.

12. The autonomous driving method of claim 1, wherein the local route planning operation comprises performing the local route plan according to an action order generated by global guidance information for at least a first subsequent global node point immediately ahead.

13. The autonomous driving method of claim 12, wherein when it is difficult to execute the local route plan according to the action order, the global guidance information for at least the first subsequent global node point is changed.

14. The autonomous driving method of claim 12, wherein the action order is generated in additional consideration of global guidance information for a second subsequent global node point.

15. The autonomous driving method of claim 14, wherein the first subsequent global node point and the second subsequent global node point are placed within a preset distance from each other.

16. An autonomous driving system comprising:
a global route module configured to search for a global route from a current location of a host vehicle to a destination and generate guidance information for a plurality of global node points on the route;
a local route module configured to acquire lane information and obstacle information within a preset distance ahead and plan a local route for at least a portion of the information within the preset distance; and
a vehicle traveling control module configured to execute autonomous driving using a vehicle driving device according to the local route plan.

17. The autonomous driving system of claim 16, wherein the global route module extracts subsequent guidance information for a location of the host vehicle, and the local route module determines a driving action using the subsequent guidance information and plans the local route in consideration of the driving action.
